(19) United States
(12) Patent Application Publication
(10) Pub. No.: US 2008/0159799 A1
(43) Pub. Date: Jul. 3, 2008

(54) Keyboard for a computer

(75) Inventors: Walter Bender, Newton, MA (US); Mark Foster, Palo Alto, CA (US)

Correspondence Address: William L. Botjer, PO Box 478, Center Moriches, NY, 11934, US

(73) Assignee: One Laptop per Child Association Inc., Cambridge, MA (US)

(21) Appl. No.: 11/986,410

(22) Filed: Nov. 21, 2007

Related U.S. Application Data
(60) Provisional application No. 60/860,722, filed on Nov. 22, 2006.

(51) Int. Cl. B41J 5/08

(52) U.S. Cl. 400/472

(57) ABSTRACT

A keyboard for a computer. The keyboard comprises a plurality of keys for providing both digital and analog inputs. Additionally, the keyboard comprises keys for functions such as activating a camera or a microphone, scrolling windows on a computer screen, and so forth. The keys are covered with a flexible keycap surface that provides resistance to elements such as water and dust.

### RELATED APPLICATIONS

This application claims priority of U.S. Provisional Patent Application Ser. No. 60/860,722, filed on Nov. 22, 2006, which is hereby incorporated by reference as if set forth herein in its entirety

### BACKGROUND

The invention relates to the field of peripheral input devices for computers. More particularly, the invention relates to the field of keyboards for computers.

Existing electronic devices can perform various multimedia and networking functions. Examples of electronic devices include personal computers, laptops, mobile phones, palm tops, and so forth. These electronic devices use keyboards as input devices. A keyboard has various keys that perform functions such as controlling volume, playing music, and opening mailbox. There are additional keys for entering text and other usual functions. However, many of these keys are not used frequently. Moreover, the size of the keyboard increases to accommodate additional keys.

Typically, the keyboard processes only digital inputs. However, for various operations, it is more convenient for a user to provide analog inputs to a keyboard. For example, analog inputs can be entered to adjust the volume, the brightness of the screen, and so forth. Additionally, keyboards are generally made of plastic, polycarbonate, stainless steel, etc. Moreover, the keyboards have spaces between the keys that make keyboards vulnerable to water and dust.

In light of the above, there is a need for a keyboard that is compact and simple to use. Moreover, the keyboard should be water-resistant and dust-proof. Further, the keyboard should have all the functionalities of the existing keyboards, and at the same time, it should eliminate keys that are not required frequently. Furthermore, the keyboard should have a provision for both digital and analog inputs.

### SUMMARY

An objective of the invention is to provide a keyboard, which is easy to use.

Another objective of the invention is to provide a keyboard which is moisture-resistant and dust-proof.

The present invention is a keyboard that has dual-mode keys. The two modes in the dual mode are: a first “analog” mode and a second “digital” mode. Either of the modes can be selected using a ‘function’ key. The function key can also be used to enable or disable the dual-mode keys. When operated in analog mode, the keys are used to control or adjust the levels in various applications such as setting the brightness level of the display screen, volume of speakers, among others. In digital mode, one of the keys can be used to display a frame on the display screen. The frame displays a search function, status of the users added to friends list of the user operating the keyboard. In addition, when operated in digital mode, a key is used to display the activities running on various computers connected in a network with the computer attached to the keyboard. In digital mode, a key is used to have a full screen view of one of the activities running on the computer attached to the keyboard. The keyboard has a key to exit from any of the activities or applications running on the computer attached to the keyboard. The keyboard also has a key that can be used to operate a number of peripheral devices such as a microphone, camera, projector, and so forth. The keyboard has a key for displaying a search user interface. The search user interface is used for searching articles, websites, journals, news, publications and so forth that contain the words typed in the search box. In addition, the keyboard has a key for selecting a language in which information is to be displayed from a number of languages. The keyboard also has a key for displaying underlying codes of the applications running on the computer, for example, underlying HTML codes of web pages; underlying codes of Word documents; etc. The key can also invoke debugger applications and editor applications. Further, the keyboard has a key which can be used in conjunction with a touchpad for the scrolling operation. In addition, the keys of the keyboard are covered by a flexible membrane which makes the keyboard moisture-resistant and dust-proof.

### BRIEF DESCRIPTION OF DRAWINGS

The preferred embodiments of the invention will hereinafter be described in conjunction with the appended drawings, provided to illustrate and not to limit the invention, wherein like designations denote like elements, and in which:

FIGS. 1a, 1b, 1c, 1d, 1e and 1f illustrate various keyboards, in accordance with embodiments of the invention; and

FIG. 2 illustrates a set of dual mode keys in a keyboard, in accordance with an embodiment of the invention.

### DETAILED DESCRIPTION

Various embodiments of the invention provide a keyboard attached to an electronic device. The keyboard includes a flexible membrane that covers all the keys in the keyboard. Moreover, the flexible membrane provides resistance to environmental factors such as dust, water, and so forth. The keyboard includes various keys that match the functions of an on-screen User Interface (UI) of the electronic device. Further, the keys have glyphs or symbols that are easy to understand. Additionally, the keyboard includes various keys that can be used for entering both analog and digital information.

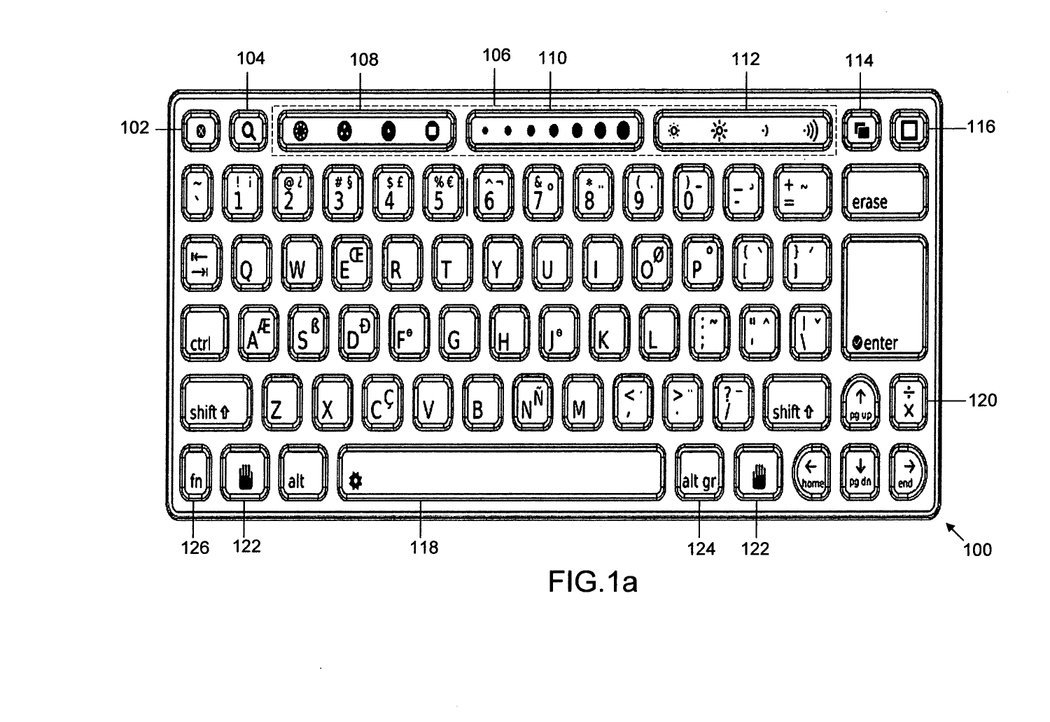

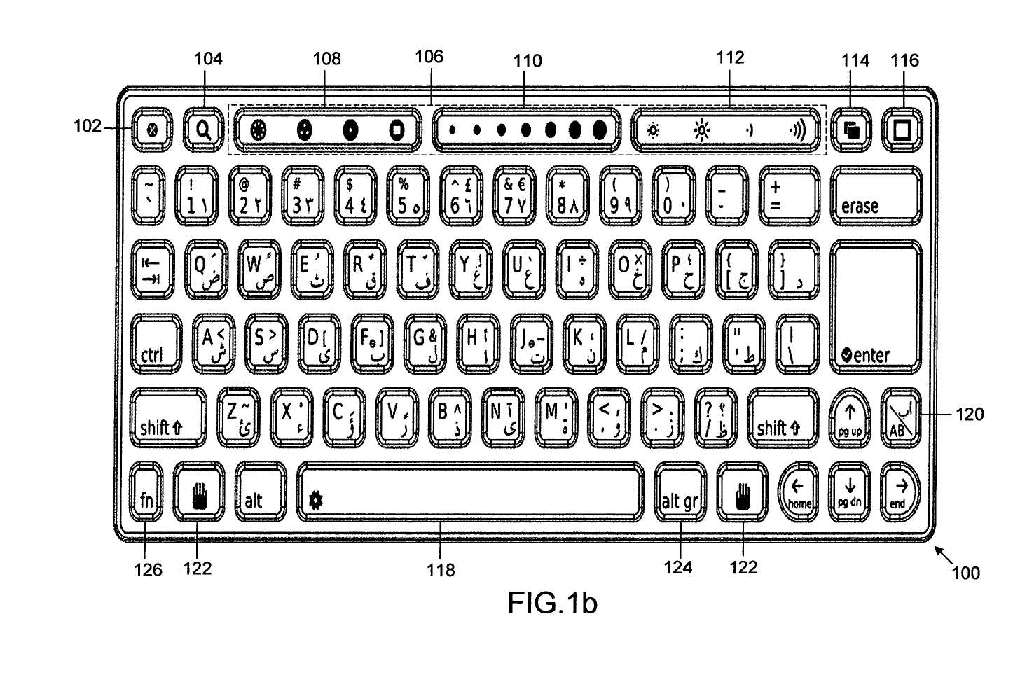

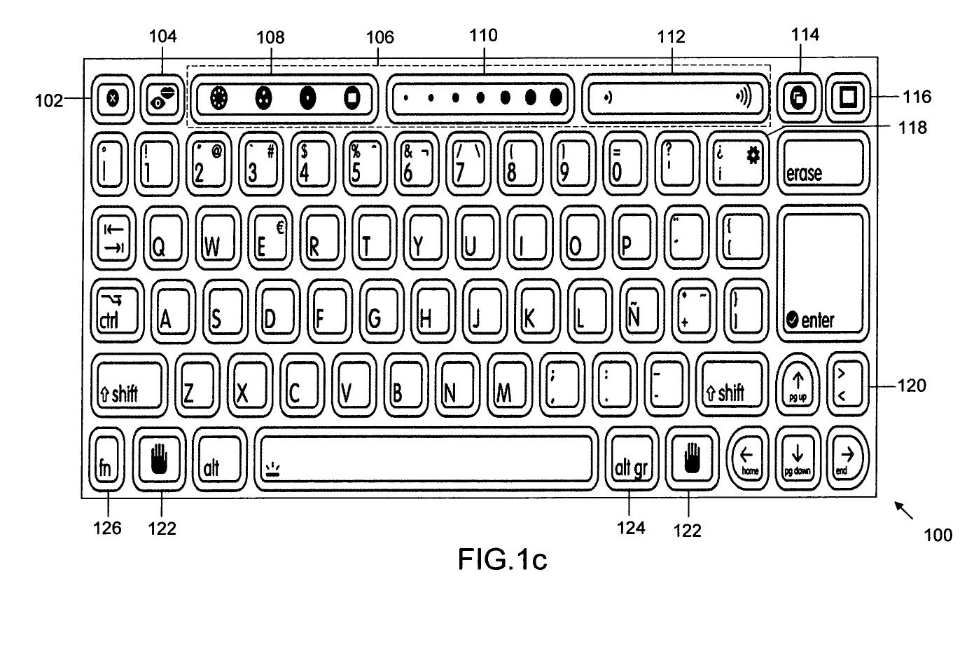

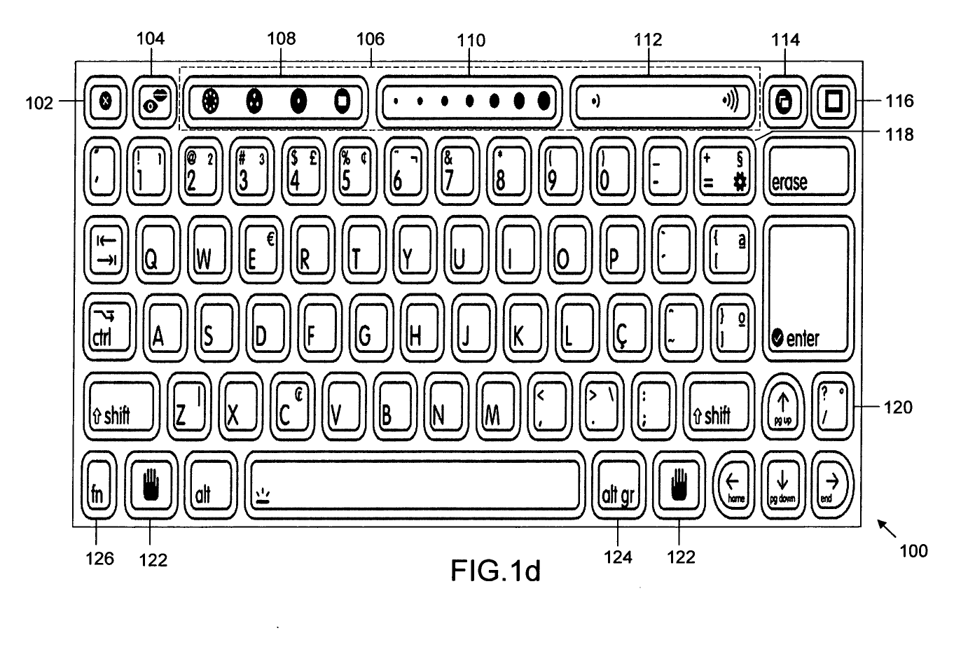

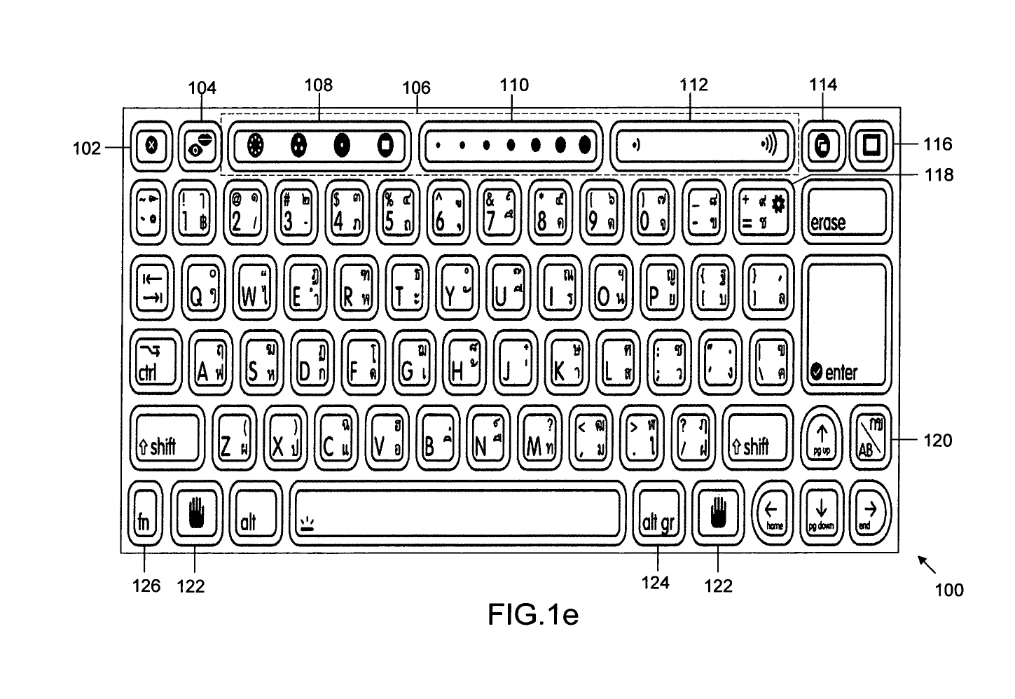

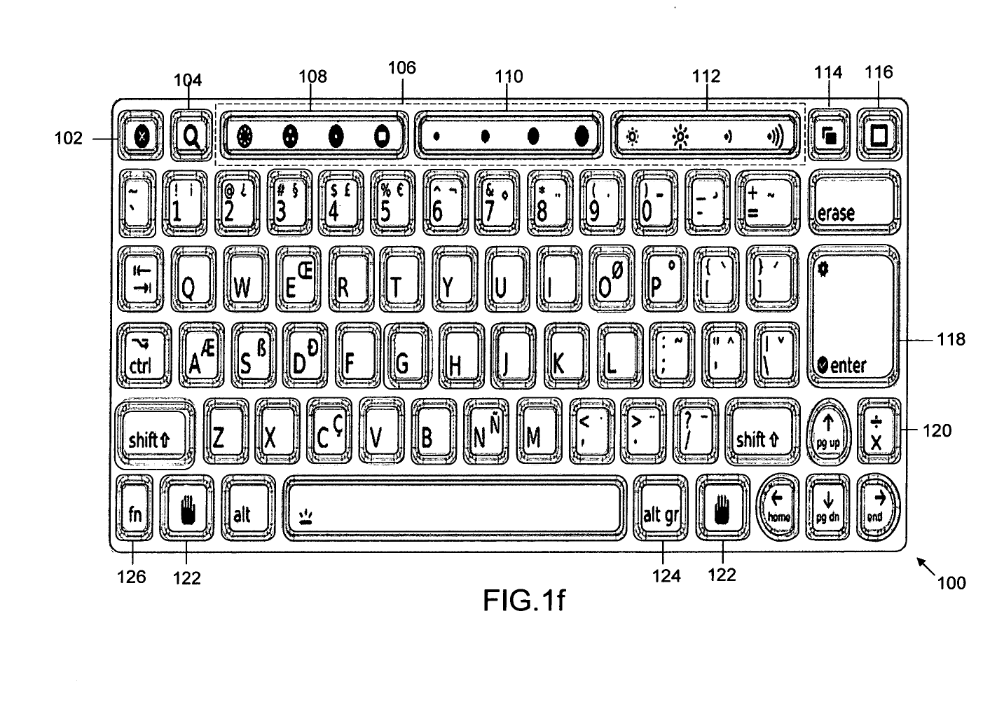

FIGS. 1a, 1b, 1c, 1d, 1e and 1f illustrate a keyboard 100, in accordance with an embodiment of the invention. Keyboard 100 is an input device for electronic devices such as a personal computer, a laptop, a palm top, and so forth. Various keys on keyboard 100 are used for conventional purposes, such as keys to input numbers, language symbols or alphabets, mathematical operators, and other keys that are known to any person skilled in the art. Moreover, keyboard 100 includes keys with functions that are different from the keys on a conventional keyboard. In an embodiment of the invention, keyboard 100 contains 72 keys for incorporating information. Each key on keyboard 100 is assigned a scan code for receiving inputs. The scan code is a binary or hexadecimal number assigned to each key on keyboard 100.

In an embodiment of the invention, pressing a key 102 closes an application running on a computer attached to keyboard 100. In another embodiment of the invention, functions of key 102 are similar to the escape key on a conventional keyboard. In an embodiment of the invention, key 102 includes a glyph printed on it. The glyph on key 102 has a cross (‘x’) on it that matches the on-screen UI of the computer. In another embodiment of the invention, key 102 includes a word printed on it, such as “esc”.

A key 104 has a glyph of a magnifying glass printed on it. When key 104 is pressed, a search user interface containing a search-box is displayed on the on-screen UI. Words can be typed or copied in the search-box for searching files, images, news articles, journals, publications and so forth on computer attached to the keyboard 100.

In another embodiment of the invention, Key 104 has a glyph of a mouth and an eye printed on it as shown in FIG. 1c. The glyph of a mouth denotes a microphone and the glyph of an eye denotes a camera. When key 104 is pressed, a microphone and camera are activated. In an embodiment of the invention, on pressing key 104, the microphone and camera are activated simultaneously. In another embodiment of the invention, the microphone and camera are activated interchangeably by repeatedly pressing key 104. In another embodiment of the invention, the microphone can be activated when key 104 is pressed in conjunction with key 126 whereas the camera can be activated when only key 104 is pressed. Alternatively, the camera is activated by pressing key 104 in conjunction with key 126. In an embodiment of the invention, the camera is activated for the duration for which key 104 is pressed and deactivated when key 104 is released. Similarly, the microphone can be activated for the duration for which key 104 is pressed and deactivated when key 104 is released. In an embodiment of the invention, peripheral devices such as USB memory drives, scanners are activated or deactivated by pressing or releasing key 104. The functions of a key 126 are similar to that of a ‘function key’ on a conventional keyboard of a laptop computer.

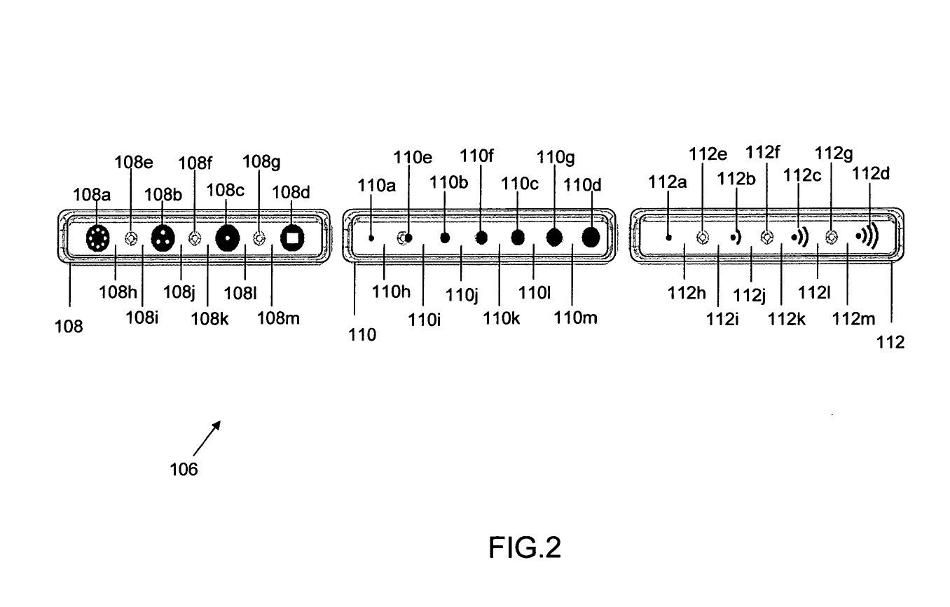

In an embodiment of the invention, keyboard 100 includes dual-mode keys 106. Dual-mode keys 106 are explained in detail in conjunction with FIG. 2.

When a key 114 is pressed, it invokes an overlay of chat windows, document sharing, Voice over Internet Protocol (VoIP), and so forth, on the on-screen UI of the computer.

In one embodiment of the invention, a key 116 has a glyph of a “frame” printed on it. The glyph matches the on-screen UI. Key 116 invokes an on-screen UI for a frame element. The on-screen UI for frame element displays a rectangular frame at the periphery of the screen. The frame element is an overlay that displays a status indicator on the computer screen. The status indicator indicates the online or offline status of computers in a network that are connected to the computer attached to the keyboard. In addition, the frame element displays a search function, active controls for various applications running on the computer, and so forth. In an embodiment of the invention, the frame element displays four “zoom” keys. The “zoom” keys will be explained in detail in conjunction with FIG. 2.

In one embodiment of the invention, a key 118, has a symbol of “gear” printed on it. Key 118, when pressed in conjunction with key 126, displays the underlying codes of documents. Key 118 also invokes editor applications and debugger applications of software programs and scripts of documents. For example, a HyperText Markup Language (HTML) code of the active page is displayed when key 118 is pressed while displaying a web page on the screen.

In an embodiment of the invention, a key 120 has a symbol of “×” and “÷” printed on it. Key 120 when pressed, multiplies two or more mathematical functions or numbers and when pressed in conjunction with key 126, divides two or more mathematical functions or numbers. In another embodiment of the invention, keyboard 100 is used to enter characters, numbers, and so forth, in Arabic and English languages. In another embodiment of the invention, keyboard 100 is used to provide input in languages such as American International, Argentinean, Brazilian, Nigerian, Arabic, Urdu, That, Spanish, Portuguese, and so forth, as shown in FIGS. 1b, 1c, 1d, 1e and 1f. Key 120 is the language select key, which, when pressed, enables the user to select symbols, characters, numbers, and so forth, in English and Arabic. FIGS. 1a, 1b, 1c, 1d, 1e and 1f are snapshots of keyboard 100, wherein each snapshot corresponds to English, Arabic, Argentinean, Brazilian and That language, respectively. In an embodiment of the invention, key 120 may have letters to indicate the language/s that can be selected for providing inputs. In an embodiment of the invention, key 120 is pressed repeatedly to select any one language from American International, Argentinean, Brazilian, Nigerian, Arabic, Urdu, That, Spanish and Portuguese and so forth.

In one embodiment of the invention, a key 122 has a glyph of a hand printed on it. Key 122, when pressed and used in conjunction with a touch pad, drags an application window to different locations on the computer screen. Key 122 can also be pressed and used in conjunction with the touch pad to scroll up or down in a window displayed on the screen. This function is similar to scrolling up or down by using a scroll bar in conventional applications in a computer.

FIG. 2 illustrates a set of dual mode keys 106 on keyboard 100, in accordance with an embodiment of the invention. Keys 106 include keys 108, 110 and 112. Keys 106 include keys that operate in a dual mode. Dual-mode keys 106 facilitate incorporating information in digital as well as analog forms. In the digital mode, keys 108, 110 and 112 function as four discrete digital keys. In an embodiment of the invention, the mode of input for keys 108, 110 and 112 can be changed from digital to analog by pressing key 126.

In an embodiment of the invention, the computer attached to keyboard 100, is connected to a network of computers. The networked computers can share various applications or interact with different applications such as paint, Internet browser, and so forth, or activities such as chatting, messaging, painting, and so forth. In the digital mode, key 108 acts as the four discrete ‘zoom’ keys, keys 108a, 108b, 108c, and 108d. In the digital mode, a scan code corresponding to the key that is pressed is received by keyboard 100. However, in the analog mode, scan codes for more than one key can be received by keyboard 100.

Key 108a, when pressed, displays information pertaining to computers sharing or performing an activity in the network. In an embodiment of the invention, key 108a has a glyph printed on its surface in the shape of a circle that includes various dots to represent the computers in the network. The glyph on key 108a matches the on-screen UI of the computer. In an embodiment of the invention, functions of key 108a also include the display of ‘away messages’ and other online messages.

Key 108b, when pressed, displays the computers in the network, which are added to a friends list of the user using keyboard 100. In an embodiment of the invention, the friends' list comprises a group of users in the network who frequently share various activities with the user. In an embodiment of the invention, key 108b has a glyph printed on its surface in the shape of a circle that includes three dots, to represent the computers in the network that are included in the friends' list. The glyph on key 108b matches the on-screen UI of the computer.

Key 108c, when pressed, displays a home view on the screen of the computer attached to keyboard 100. In an embodiment of the invention, the home view includes a display of all the activities running on the computer comprising keyboard 100. In an embodiment of the invention, key 108c has a glyph printed on its surface in the shape of a circle that includes a single dot to represent the home view. The glyph on key 108c matches the on-screen UI of the computer. For example, activities such as painting, writing, messaging, etc., are running on various computers in the network. If key 108c is pressed, various activities running on the various computers in the network are displayed on the computer screen of the computer to which the keyboard is attached. The various activities are displayed with a unique color assigned to each activity.

Key 108d, when pressed, displays a full-screen view of an activity running on the computer comprising keyboard 100. In an embodiment of the invention, key 108d has a glyph printed on its surface in the shape of a circle circumscribing a rectangle, to represent the full-screen view. The glyph on key 108d matches the on-screen UI displayed on the computer.

In the analog mode, keys 108e, 108f and 108g are enabled for incorporating information. In the analog mode, combinations of keys 108 a-g can be pressed simultaneously to input information. When a single key is pressed, keyboard 100 receives a single scan code that is assigned to the pressed key. When multiple keys are pressed simultaneously, keyboard 100 receives multiple scan codes assigned to the pressed keys. Therefore, the computer attached to keyboard 100 receives an input, which is calculated, based on the multiple scan codes assigned to the keys that are pressed. Points 108h, 108i, 108j, 108k, 108l and 108m represent the calculated values in an increasing order. If multiple keys are pressed, an interpolated value is calculated that is a function of the pressed keys. In an embodiment of the invention, the calculated values can be obtained by interpolating the received multiple scan codes resulting from multiple key presses. In another embodiment of the invention, in the analog mode, key 108 is used to adjust the brightness of the computer screen.

In an embodiment of the invention, in the digital mode, key 110 functions as four discrete digital keys to input information. In an embodiment of the invention, keys 110a-d are used for zooming on-screen UI. In the analog mode, keys 110e, 110f and 110g are enabled for incorporating information. In the analog mode, combinations of keys 110 a-g can be pressed simultaneously for incorporating information. Points 110h, 110i, 110j, 110k, 110l and 110m represent values calculated from scan codes corresponding to multiple key presses. In an embodiment of the invention, in the analog mode, key 110 is used for various applications such as zooming on-screen UI, volume control, brightness control, and so forth. For instance, let us assume that key 110b corresponds to zoom of 100 percent and key 110d to a zoom of 300 percent. If both these keys are pressed simultaneously, an intermediate value of the zoom percentage is calculated, for example, 200 percent.

In an embodiment of the invention, key 112 operates as four discrete keys, namely 112a, 112b, 112c and 112d, in the digital mode. In an embodiment of the invention, keys 112a-d are used to adjust volume levels in the computer. In the analog mode, keys 112e, 112f and 112g are enabled to input information. Further, in the analog mode, combinations of keys 112 a-g can be pressed simultaneously to provide the input information. Points 112h, 112i, 112j, 112k, 112l and 112m represent values calculated from scan codes corresponding to multiple key presses. In another embodiment of the invention, in the analog mode, key 112 is used to adjust the volume of various voice applications, such as voice chat, adjustment of the brightness of the screen, and so forth, for example, when adjusting the volume of the speakers connected to the computer. For instance, if keys 112e and 112b are pressed simultaneously and if key 112e corresponds to a volume level of 2 and key 112b corresponds to a volume level of 4, then an interpolated volume level of 3 is obtained.

In an embodiment of the invention, all the keys on keyboard 100 are covered by a flexible membrane. Examples of the material used as the flexible membrane include rubber, plastic, and so forth. The flexible membrane covers the keys to make the keyboard resistant to dust and water.

In an embodiment of the invention, the keys on keyboard 100 require a keystroke weight in the range of 40 to 70 grams. This keystroke weight is the amount of force required for pressing and operating a key.

Keystroke travel of the keys of keyboard 100 is in the range of 1 mm to 1.2 mm. The keystroke travel is the distance covered by a key when it is pressed, for the key to operate satisfactorily.

Embodiments of the invention have one or more of the following advantages over the conventional keyboards. The keyboard presented in the invention has keys that are easy to use. Moreover, the keyboard has keys that provide dual-mode functions for digital and analog input. The flexible keycap surface protects the keyboard from elements such as water and dust.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A keyboard for a computer, the computer being connected to the keyboard, the keyboard comprising:
a plurality of keys, wherein the plurality of keys operate in dual mode, the dual mode being an analog mode and a digital mode.

2. A keyboard for a computer, the computer being connected to the keyboard, the keyboard comprising:
a plurality of keys, wherein the plurality of keys operate in dual mode, the dual mode being a first mode and a second mode, wherein inputs are being processed in the first mode to adjust the levels in various applications mode and in the second mode the keys are used to display a frame or application on the display screen.

3. The keyboard according to claim 1, wherein the plurality of keys comprise at least one glyph printed on each of the plurality of keys, each of the at least one glyph being based on a User Interface (UI) displayed on screen of the computer.

4. The keyboard according to claim 1, wherein the keyboard further comprises a flexible membrane for covering the plurality of keys.

5. The keyboard according to claim 1, wherein the keyboard further comprises a key for displaying a plurality of computers connected in a network.

6. The keyboard according to claim 1, wherein the keyboard further comprises a key for displaying activities running on a plurality of computers connected in a network.

7. The keyboard according to claim 1, wherein the keyboard further comprises a key for displaying messages received from at least one of a plurality of computers a network.

8. The keyboard according to claim 1, wherein the keyboard accepts simultaneous inputs from the plurality of keys.

9. The keyboard according to claim 8, wherein the simultaneous input generates a single output.

10. The keyboard according to claim 9, wherein the single output is calculated by interpolation of simultaneous inputs.

11. The keyboard according to claim 1, wherein the keyboard comprises a key for displaying a search user interface.

12. The keyboard according to claim 1, wherein the keyboard comprises a key for activation of a plurality of peripheral devices connected to the computer.

13. The keyboard according to claim 12, wherein the plurality of peripheral devices are activated simultaneously.

14. The keyboard according to claim 12, wherein the keyboard comprises a key for operating a camera connected to the computer.

15. The keyboard according to claim 12, wherein the keyboard comprises a key for operating a projector.

16. The keyboard according to claim 1, wherein the keyboard comprises one or more keys for controlling level of volume of sound, the level of volume of sound being computed from inputs from one or more keys.

17. The keyboard according to claim 1, wherein the keyboard comprises one or more keys for setting levels for a plurality of applications running on the computer.

18. The keyboard according to claim 1, wherein the keyboard comprises at least one key for invoking software program or script editors and debuggers.

19. The keyboard according to claim 1, wherein the keyboard comprises at least one key for invoking an overlay of a plurality of applications running on the computer.

20. The keyboard according to claim 1, wherein the keyboard comprises a key for selecting a language to be used as input for the computer.

21. The keyboard according to claim 1, wherein the keyboard comprises a key for scrolling within an application running on the computer.
